(19) United States
(12) Patent Application Publication
(10) Pub. No.: US 2025/0299054 A1
(43) Pub. Date: Sep. 25, 2025

(54) RUBRIC BASED SELF LEARNING METHODS AND SYSTEMS IN AN ARTIFICIAL INTELLIGENCE ENVIRONMENT

(71) Applicant: Soham Pranav Shah, Redwood City, CA (US)

(72) Inventor: Soham Pranav Shah, Redwood City, CA (US)

(73) Assignee: Ema Unlimited Inc., Mountain View, CA (US)

(21) Appl. No.: 18/983,794

(22) Filed: Dec. 17, 2024

Related U.S. Application Data
(63) Continuation-in-part of application No. 18/610,276, filed on Mar. 20, 2024.

(51) Int. Cl. G06N 3/091

(52) U.S. Cl. CPC G06N 3/091

(57) ABSTRACT

Systems and methods for an artificial intelligence (AI) agent to perform self-learning, self-evaluation based on a rubric and then perform self-correction as needed is described. The methods generate a rubric. The rubric includes the AI agent's performance data and evaluations of the data and related feedback by a separate LLM and a human agent. Once a level of confidence is achieved that the AI agent is performing at a threshold confidence level of the human agent, or that the separate LLM is evaluating the AI agent's performance within a threshold confidence of the human agent's evaluation of the same, the rubric in which the AI agent's performance and evaluation data is inputted is determined to be complete for use in a self-evaluation. The AI agent may then use the rubric to self-evaluate and self-correct its performance without a need for human evaluation.

### CROSS-REFERENCE TO RELATED APPLICATIONS

This application is a continuation-in-part of U.S. patent application Ser. No. 18/610,276, filed Mar. 20, 2024, the disclosures of these applications are incorporated herein by reference in their entirety.

### FIELD OF DISCLOSURE

Embodiments of the present disclosure relate to autonomous methods and systems in an artificial intelligence environment that are capable of self-learning, self-evaluating, and self-correcting its algorithms, workflows, workflow steps, and deep learning models to provide a result or response to a user query.

### BACKGROUND

Generative artificial intelligence (AI) systems are currently used for several use cases. They leverage language models, such as large language models (LLMs), to create content, such as text, or provide responses to user queries. Chatbots, such as ChatGPT™, Gemini™ Copilot™, leveraged AI generative systems to provide responses to such user queries. They are currently being used in a variety of fields, just as in medicine, engineering, computer science, education. The AI generative systems are able to perform complex tasks such as code generation, provide a better and customized search, or simply help compose an email or a letter.

To be able provide responses to queries, generate documents or code, and add other type of value, such as composing the email, the LLMs used by the AI generative systems are trained with massive amounts of data, such as petabytes or exabytes of data. The LLM works by creating relationships between words and sentences from this massive set of data. Once the training is completed, the LLM uses predictive analytics to process next words until a certain length is reached to provide a coherent and contextually relevant text to a query.

Although current LLMs are useful in responding to certain user requests, they are still in their early stages and have a lot of improvement ahead of them. For example, one of the drawbacks of the current AI system is their ability to be self-critical to the response it generated. Since LLMs lack such an ability, the response they provide may lack accuracy and/or be relevant in certain cases.

If an LLM provides an inaccurate or incoherent response, or a response that is generated by hallucination, the user simply is not aware that such a response is inaccurate, incoherent, or generated based on hallucination, and may take the LLM's word for it. Such adoption of an inaccurate or incoherent response, or a response generated based on hallucination, may cause embarrassment to the user if the user shares the response without correcting it. It may also cause lack of trust and professional and legal consequences, such as affect the user's professional or academic integrity, cause copyright issues, or cause the user to lose a business deal for the user's lack of professionalism.

If the user recognizes that the LLM provided response is inaccurate or incoherent response, or a response that is generated by hallucination, the user's recourse is to keep revising their prompt and asking a more refined query. Although the manual prompt refining process by the user may potentially yield better results, it is largely dependent on the user's skill to ask a better and more refined query and is laborious and cumbersome that utilizes human trial and error techniques. Furthermore, even after the prompt is refined, the LLM may produce yet another response which may also be inaccurate or incoherent response, or a response generated based hallucination, which again requires the human to be knowledgeable enough to recognize that the response is inaccurate, incoherent, not relevant, or has some other issues.

As such, there is a need for methods and systems that provide self-learning, self-evaluation, and self-corrections mechanisms to identify and correct their processes without user intervention.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. Various objects and advantages of the disclosure will be apparent upon consideration of the following detailed description, taken in conjunction with the accompanying drawings, in which like reference characters refer to like parts throughout, and in which:

FIG. 1 is a block diagram of a self-evaluation and self-correction process in an artificial intelligence environment for providing an enhanced outcome, in accordance with some embodiments of the disclosure;

FIG. 2 is a block diagram of an example of a system for performing a self-evaluation and self-correction process in an artificial intelligence environment for providing an enhanced outcome, in accordance with some embodiments of the disclosure;

FIG. 3 is a block diagram of an example of an electronic device or user device for performing a self-evaluation and self-correction process in an artificial intelligence environment for providing an enhanced outcome, in accordance with some embodiments of the disclosure;

FIG. 4A is flowchart of an example for generating a rubric used in the self-evaluation and self-correction process in the artificial intelligence environment, in accordance with some embodiments of the disclosure;

FIG. 4B is an example of a system for generating a rubric used in the self-evaluation and self-correction process in the artificial intelligence environment, in accordance with some embodiments of the disclosure;

FIG. 5 is an example of a user interface used by a human agent to score and evaluate an AI agent's performance, in accordance with some embodiments of the disclosure;

FIG. 6 is an example of components of a rubric, in accordance with some embodiments of the disclosure;

FIG. 7 is flowchart of a process for generating and updating the rubric based on confidence level, in accordance with some embodiments of the disclosure;

FIG. 8 is an example of a plurality of workflows generated by the AI agent, in accordance with some embodiments of the disclosure; and

FIG. 9 is an example of a plurality of LLMs that may be used to generate workflows and perform rubric based self-evaluation and self-correction, in accordance with some embodiments of the disclosure.

### DETAILED DESCRIPTION

In accordance with some embodiments disclosed herein, some of the above-mentioned limitations are overcome by generating a rubric, updating the rubric until a threshold confidence level is reached, and using the rubric as one of the criteria, for self-learning, self-evaluating, and self-correcting algorithms, workflow steps, and deep learning models to provide a more accurate, coherent, and enhanced response to a user query.

In accordance with some embodiments disclosed herein, some of the above-mentioned limitations are also overcome by generating the rubric based on input from both an LLM and a human agent. The LLM which provides the input may be a separate LLM (e.g., a second LLM) than the LLM leveraged by the AI agent.

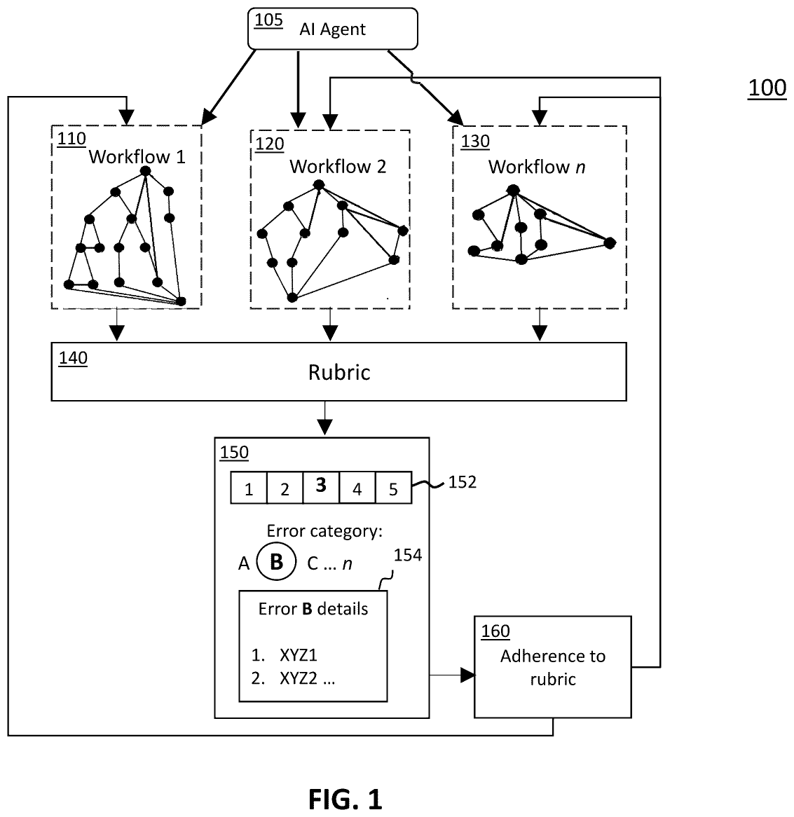

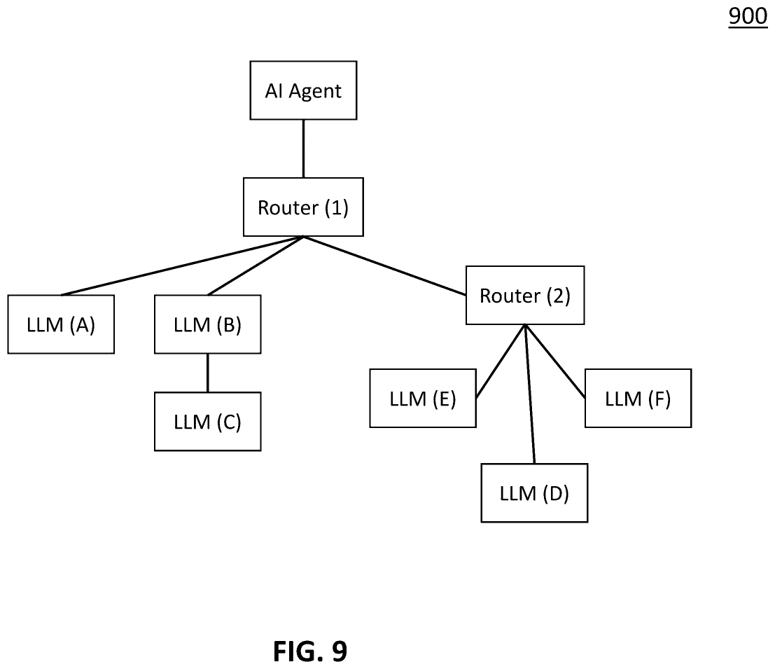

In some embodiments, an AI agent may generate one or more workflows to respond to a user query, such as workflows 110-130 in FIGS. 1 and 910-930 in FIG. 9. The generation of workflow may be performed using one or more embodiments as described below. For example, in one embodiment, an AI generative engine or system may engage in an interactive conversation with a user to obtain user query and learn, among other information, the user's persona, the task to be performed, the industry related to the task, and how the user desires to use the configurable application to perform the task. The interactive conversation may be between an automatically generated AI agent, which may be generated by the generative AI system using the control circuitry.

Once one or more workflows are generated, in some embodiments, the AI agent may select one or more workflows to answer the user's query or provide a response in the format requested, such as an email, a document, a report, an excel sheet with calculations, a full comprehensive document, such as a response to a request for proposal, or a story with chapters for a book. In some embodiments, the AI agent may select the single workflow from the multiple workflows generated, based on factors such as the workflow's suitability for the task or historical usage within the corporation or one of the workflows. In other embodiments, the AI agent processes multiple workflows, compares the generated responses from the multiple workflows, and then selects the most accurate or relevant response.

In some embodiments, the AI agent may use a workflow that leverages a company's knowledge base that can be accessed by an LLM to answer the user's query while in another embodiment, the AI agent may select a workflow that requires performing an API call to an external application that can perform some of the steps of the workflow.

Regardless of whether a single or multiple workflows are utilized, or the type of workflow used, once the one or more workflows are used by the AI agent and a response is obtained, the AI agent may self-evaluate the response using a rubric.

The self-evaluation process performed by the AI agent may involve a plurality of self-evaluation aspects that may be included in a rubric. In some embodiments, the self-evaluation may be to determine the accuracy of the response and in other embodiments it may be to determine relevance of the response to the initial query, suitability for the response to the persona of the user that entered the query, and/or the associated costs and time involved to obtain the response. This self-evaluation may not be limited to the response but may also be applied to the workflow steps used in obtaining the response. For example, if the workflow steps involve overly complex, time consuming, or use of external applications, this may also be considered in the self-evaluation. In one embodiment, all such self-evaluation, including its various aspects of the self-evaluation may be based on a pre-generated rubric. In another embodiment, although the rubric may have already been generated, it may be continuously updated and the most updated rubric may be used for the self-evaluation.

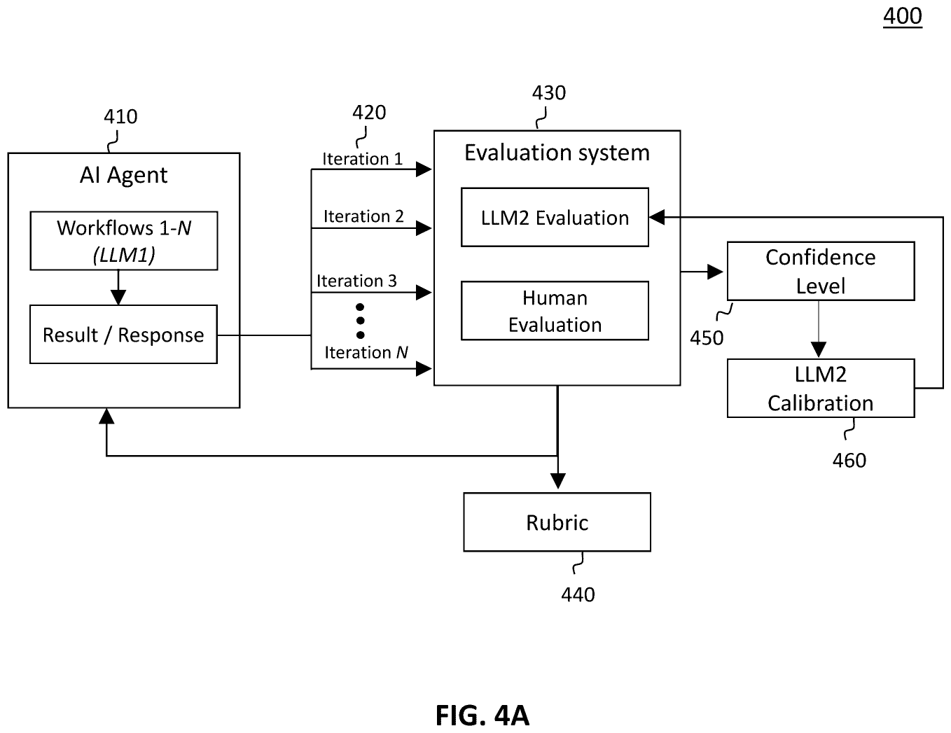

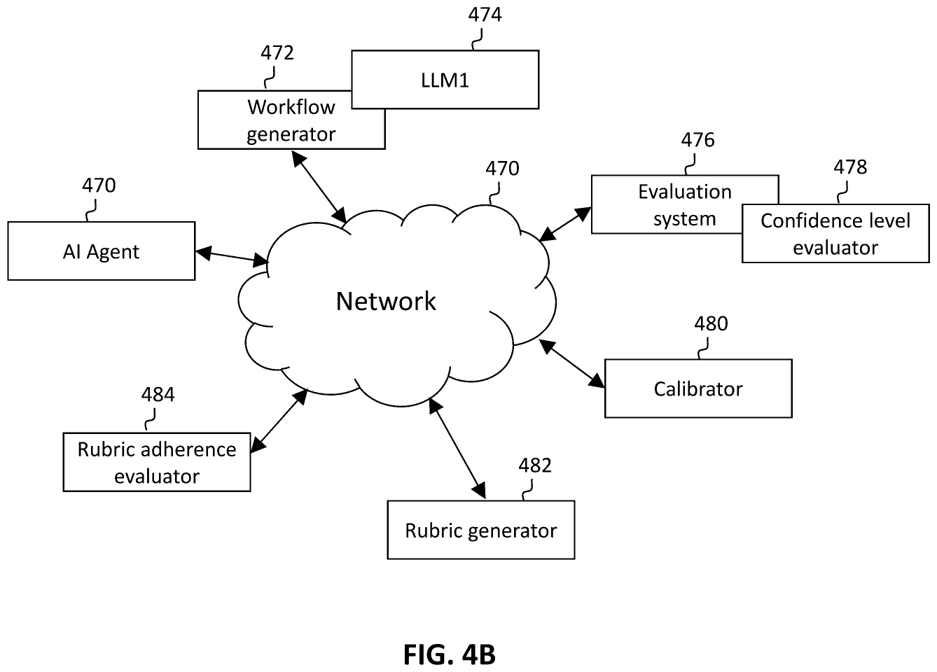

The rubric may be generated, in some embodiments, based on an initial processing of projects by the AI agent using one or more workflows, as further described in the description related to FIGS. 4-6. In this embodiment, the AI agent may process a sample size of projects, such as, for example, a sample of 50, 100, 1000, 3000 projects. The sample size may vary and may not be a predetermined fixed number. For each project processed by the AI agent using a workflow, the response that results from the workflow may be evaluated by a) a separate LLM (a second LLM) not leveraged by the AI agent and b) a human. The projects in this initial sampling may be any type of project, such as, for example, a project to answer a user query, troubleshoot and provide a resolution to a network management related trouble ticket, generate code for a program, or whatever the user request may be.

When the separate LLM (second LLM), i.e., the LLM not leveraged by the AI agent, evaluates the result or response for the workflow processed by the AI agent as well as the workflow steps to obtain such response/result, separate, independent, and unbiased judgement of the result/response for the workflow processed by the AI agent as well as the workflow steps to obtain such response/result processed by the AI agent may be obtained. The second LLM, in evaluating the result/response for the workflow processed by the AI agent as well as the workflow steps to obtain such response/result, may utilize a plurality of embodiments. In one such embodiment, the LLM may leverage a semantic graph that it may automatically generate based on institutional knowledge and private enterprise data from multiple sources. The semantic graph may be a type of knowledge graph that represents the relationships between data stored at various locations in an enterprise. It may be generated automatically by the LLM through various techniques, such as text mining, machine learning, deep learning, or based on user login when the user accesses certain databases. The semantic graph may index data from across the private enterprise such that when a query or a project, such as a workflow executed by the AI agent and the result/response from the workflow is inputted, the separate LLM may be able to leverage the indexed data to evaluate the result/response for the workflow processed by the AI agent as well as the workflow steps to obtain such response/result. The result of the evaluation may be an evaluation score, such as for the response/result, for the workflow overall, or for each specific step or combination of steps of the workflow as well as each interim result from each step of the workflow. In some embodiments, separate scores for each step or group of steps and the response/result obtained by an AI agent may be provided by the separate (e.g., second) LLM and all the scores may be combined, such as by using an average, mean, or standard deviation. The result of the evaluation by the second LLM may also be a detailed itemized evaluation of each step or a group of steps of the workflow and the response/result, or it may be customized to provide an evaluation of certain components of the workflow steps or response/result in a desired format. In another embodiment, the second LLM, in evaluating the result/response for the workflow processed by the AI agent as well as the workflow steps to obtain such response/result, may leverage its training data for the evaluation. In yet another embodiment, the second LLM, in evaluating the result/response for the workflow processed by the AI agent as well as the workflow steps to obtain such response/result, may generate a plurality of nested LLMs that are domain specific to then evaluate each step or a group of steps of the workflow and the response/result based on the step, group of steps, or the response/result's relevance to the domains of the generated nested LLMs.

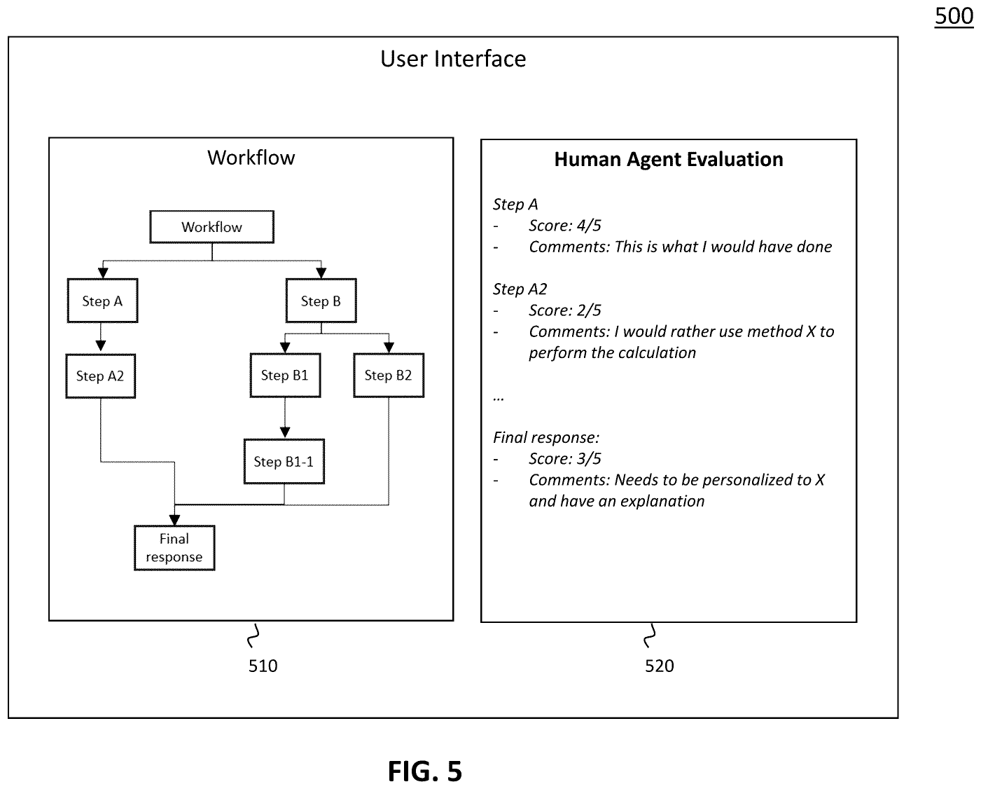

As described earlier, the evaluation of the result/response for the workflow processed by the AI agent as well as the workflow steps used by the AI agent to obtain such response/result may be evaluated by a human agent. One example of such an evaluation by the human agent using a user interface is depicted in FIG. 5. The human agent's response may provide, separate, independent, and unbiased judgement of the result/response for the workflow processed by the AI agent as well as the workflow steps to obtain such response/result. The human response may be used to determine what would have been the steps taken, processes used, and workflow followed if a human agent were to perform the same task as performed by the AI agent to obtain the response. In other words, the evaluation may provide insights, which may be used in the rubric, as to whether the human agent would have used similar workflow steps as the AI agent, obtained the result/response, or if deviated from the workflow steps or the result/response, what would be the deviations and what changes in the process and result/response would result from such deviation. The result of the human evaluation may be an evaluation score, such as for the response/result, for the workflow overall, or for each specific step or combination of steps of the workflow as well as each interim result from each step of the workflow. The result of the human evaluation may also be a detailed itemized evaluation that evaluates each step or a group of steps of the workflow and the response/result, or the human may provide another type of evaluation response which may be evaluated by yet another LLM, e.g., a third LLM, to provide a score for the workflow steps and result obtained by the AI agent. In yet another embodiment, the human may be blindly given the same task and not informed of the workflow steps and response/result obtained by the AI agent, and the human agent's performance of the task and the response/result may be evaluated with a yet another LLM, e.g., a third LLM, to then be used have the third LLM automatically evaluate the AI agent's workflow steps and the response/result based on the human agent's performance of the task and the response/result.

Once the second LLM and the human agent's evaluation of the result/response for the workflow processed by the AI agent as well as the workflow steps to obtain such response/result is obtained, the evaluation of both second LLM and the human agents may be compared.

In some embodiments, the comparison may be between the evaluation score from the second LLM and the human evaluation. In this embodiment, the LLM score may be calibrated based on the human score such that the second LLM's evaluation score aligns with the human score. Such calibration may be performed using calibration techniques such as direct comparison techniques, statistical techniques, or a common scale or standard technique.

In some embodiments, direct comparison between the evaluation scores may be performed. Either the second LLM's score may be directly calibrated to the same score as the score for the human evaluation or a common standard may be generated based on the human evaluation and the second LLM's score may be calibrated to the common standard.

Although calibration of the second LLM, an LLM separate from the LLM leveraged by the AI agent, is described as being calibrated, the calibration process may also (or instead of) be applied directly to the LLM leveraged by the AI agent. In this manner, the LLM leveraged by the AI agent may be calibrated to the human agent and then the AI agent may rerun the workflow, leveraging the calibrated LLM, to determine whether the calibration made the AI agent's workflow and results above a confidence threshold of the human agent, such as by initially having the human agent evaluating the AI agent's performance. If further calibration is needed, then the LLM leveraged by the AI agent would be once again calibrated to the human agent and the AI agent may rerun the workflow. The process may repeat until the AI agent's workflow and results exceed a confidence threshold of the human agent. In certain circumstances, just a single calibration may be sufficient to have the LLM leveraged by the AI agent align with the human agent above a confidence threshold and in other embodiments, with each iteration of calibration, the AI agent's processed and results, which leveraged the calibrated LLM, would be closer to those of the human agent.

In yet other embodiments, although calibration of the second LLM, an LLM separate from the LLM leveraged by the AI agent, is described as being calibrated, the calibration process may to the workflow used by the AI agent to obtain a response to the query. In this embodiment, the workflow may be calibrated to the workflow used by the human agent or it may be calibrated to reach a final score or final result that is same or within a threshold of the final score or final result reached by the human agent if the human agent was provided the same query to blindly, without insight into the AI agent's performance, generate a response.

In other embodiments, the calibration may utilize statistical techniques, such as linear regression, to model the relationship between the two workflows used by the second LLM and the human agent. In this embodiment, both the second agent and the human agent may be given the same task as the AI agent and then the workflows used by each may be compared to then calibrate the second LLM's workflow to the workflow used by the human agent. In other embodiments, instead of providing the same task to the second LLM and the human agent, each would simply provide input on the workflow steps used by the AI agent and input on the final response/result obtained by the AI agent based on the workflow used. Statistical techniques, such as linear regression, may then be used to calibrate the second LLM's input on workflow steps and final result/response to the inputs by the human agent for the same workflow steps and result/response.

In yet other embodiments, calibration techniques that involve a common set of reference points may be used. In this embodiment, both the second LLM and the human evaluation of the workflow steps used by the AI agent as well as the final result/response may be used to generate a scoring scale. Such scoring scale may then be used to calibrate the LLM evaluation to the scoring scale.

In some embodiments, calibration between the second LLM and the human evaluation may be of several different types, including, direct alignment, selective alignment, enhanced alignment, and outcome alignment calibration. These calibrations may be to the evaluations of the result/response for the workflow processed by the AI agent as well as the workflow steps to obtain such response/result or each second LLM and human agent may be given the same task as the AI agent and the calibration may be to the result/response and the workflow used by each, i.e., the second LLM and the human agent. Although a few types of calibrations are discussed, the embodiments are not so limited and other embodiments to calibrate the second LLM's evaluation to the human agent are also contemplated.

In some embodiments, direct alignment technique may be used to calibrate the second LLM to the human agent. This direct calibration technique may be applied to the second LLM's evaluation of the AI agent's workflow process and result to the human agent's evaluation of the AI agent's workflow process and result. If the second LLM and the human agent are fed in the same task as the AI agent, then the calibration may be to the second LLM's workflow process and result to the human agent's workflow process and result. This technique may be used to directly mirror or replicate the LLM's workflow steps and the final result/response or the LLM's evaluation of the AI agent to directly mirror the human agent. In other words, if the direct approach may use the human's workflow steps and final result as the template to which the second LLM's workflow and/or evaluation is to be mapped. Such direct calibration techniques may be used to mimic human reasoning and decision-making processes. For example, if a human takes 6-workflow steps to perform the same project performed by the AI agent, then the second LLM may be calibrated such that it also performs the same 6-steps.

In some embodiments, selective alignment techniques may be used to calibrate the second LLM to the human agent. This selective alignment calibration technique may be applied to the second LLM's evaluation of the AI agent's workflow process and result to the human agent's evaluation of the AI agent's workflow process and result. If the second LLM and the human agent are fed in the same task as the AI agent, then the calibration may be to the second LLM's workflow process and result to the human agent's workflow process and result. In this embodiment, the system may acknowledge the potential for human error, redundancy, inaccuracy, and selectively calibrate certain workflow steps and certain interim and portions of the final response and result to avoid such errors, redundancies, and inaccuracies. Accordingly, in the selective approach, may involve using an LLM, such as yet another separate LLM, to identify areas where the human's workflow steps could be improved and then calibrating the second LLM to bypass or enhance the workflow steps that may have caused the errors, redundancies, and inaccuracies. As such, the calibration may be performed selectively while ensuring that best of both the second LLM and the human agent evaluation, workflow steps, and final result/response is used to calibrate the second LLM.

In some embodiments, enhanced alignment techniques may be used to calibrate the second LLM to the human agent. This enhanced alignment calibration technique may be applied to the second LLM's evaluation of the AI agent's workflow process and result to the human agent's evaluation of the AI agent's workflow process and result. If the second LLM and the human agent are fed in the same task as the AI agent, then the calibration may be to the second LLM's workflow process and result to the human agent's workflow process and result. In this embodiment, a more sophisticated approach to calibration that may utilize a third LLM may be used. The process may include evaluating a) the evaluation of the AI agent, which include evaluation of the final result/response as well as the workflow steps used by the AI agent to obtain the final result/response by the human agent or b) if human agent is blindly given the same task as the AI agent, to then evaluate the workflow steps and the final result/response of the human agent. The third LLM may analyze a) or b, depending on the approach used, and identify areas for improvement that may include quality of the human's evaluation, workflow steps used and final result/response, human agent's skill set, education, biases or limitations, human agent's job function, and determine enhancements for the workflow overall, certain steps of the workflow, or to the final result/response. Once the third LLM provides its adjustments to the human agent's workflow steps used and final result/response, the second LLM may then be calibrated to the adjustment made.

In some embodiments, outcome alignment technique may be used to calibrate the second LLM to the human agent. This outcome alignment calibration technique may be applied to the second LLM's evaluation of the AI agent's workflow process and result to the human agent's evaluation of the AI agent's workflow process and result. If the second LLM and the human agent are fed in the same task as the AI agent, then the calibration may be to the second LLM's workflow process and result to the human agent's workflow process and result. In this embodiment, a flexible calibration approach that focuses on achieving the final response/result by the human agent may be used. This technique may not replicate the workflow used and be flexible to any workflow as long as the final response/result of the second LLM meets that of the human agent. As such, this embodiment may allow the second LLM greater autonomy to explore different approaches and strategies, as long as the final response/results meets or is within a predetermined threshold of the final result/response or evaluation score of the human agent.

While the techniques described above (direct alignment, selective alignment, enhanced alignment, and outcome alignment) offer a range of calibration approaches, the embodiments are not so limited and other calibration approaches may also be used. For example, in some embodiments, implementations, a combination of direct alignment, selective alignment, enhanced alignment, and outcome alignment may be used. In other embodiments, the human response may be analyzed to ensure it is sensitive and appropriate for the user that asked the query. This analysis may include considering factors such as the user's gender, ethnicity, skill set, and job title, and other persona related data. By taking these persona-specific factors into account, the second LLM may be calibrated to the human agent while being tailored to account for the persona-specific factors.

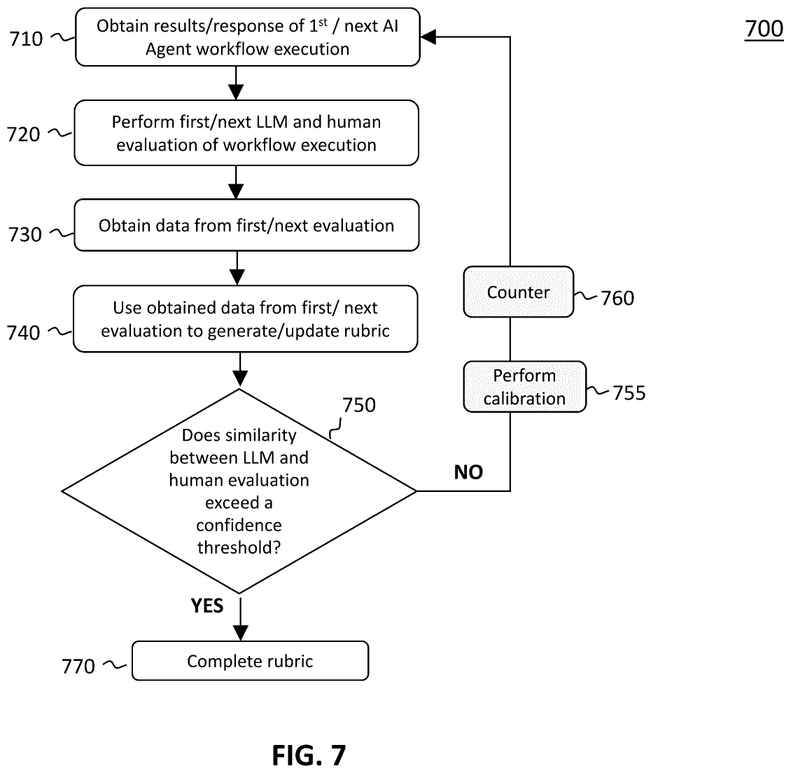

In some embodiments, as part of the initial sampling as described earlier, a certain number of projects may be executed by the AI agent. These projects may be to address user queries, generate documents or code, provide a response in a customer service setting, solve complex network latency issues, or provide an answer or response to any type of request. For each of such requests, queries, and projects, the AI agent, leveraging an LLM may generate one or more workflows. As described earlier, the AI agent's execution using the generated one or more workflows, interim results of each workflow step, and the final result/response may be evaluated by the separate (second) LLM and human agent and the LLM workflow steps, result/response, and evaluation may be calibrated using one or more of the calibration techniques described above. As each iteration of the project or query is executed in this initial sampling, the second LLM evaluation, the human agent evaluation, the calibrated workflow steps and results, may all be used as input to generate a rubric. The rubric may be updated and modified with each new project completed by the AI agent with the evaluation performed by the separate second LLM and the human agent and the resultant calibration. The initial sampling may continue until a threshold confidence level is reached that the second LLM response, including the workflow steps, are within a threshold of the human agent's response, as further described in the description related to FIG. 7. Such confidence level may also depend on whether direct alignment, selective alignment, enhanced alignment, or outcome alignment calibration technique is used.

In one embodiment, a direct alignment calibration approach is used, which may involve the separate LLM, e.g., the second LLM, to be aligned with the human agent response, either exactly or within a predetermined threshold. In this embodiment, for each project executed by the AI agent, the second LLM's evaluation of the AI agent's workflow, steps of the workflow, interim results of each workflow step, the final response/result, or an evaluation score may be compared with the human agent. When a discrepancy is determined, e.g., the second LLM not having alignment within a threshold of the human agent's evaluation of the same, then the second LLM may be calibrated to the human agent's evaluation of the AI agent's workflow, steps of the workflow, interim results of each workflow step, the final response/result. Thereafter a second project may be executed by the AI agent which may be by the AI agent generating other workflows that are separate or similar to the earlier round. The AI agent's AI agent's workflow, steps of the workflow, interim results of each workflow step, the final response/result from this second round may again be evaluated by the second LLM which was previously calibrated in the last round. Again, a determination may be made whether the second LLM's evaluation in the second round is within a threshold of the human agent's evaluation. If not, then the second LLM may again be calibrated to be within a threshold of the human agent's response. Third, fourth, fifth, sixth, to nth round may be executed until the LLM's evaluation based on previous calibrations is within the threshold of the human agent's evaluation of the AI agent. If the LLM's evaluation based on previous calibrations is within the threshold of the human agent's evaluation of the AI agent, then a determination may be made that the confidence level has been reached and that the initial round of sampling to generate the rubric is completed. As described earlier, the confidence level process may be applied also when the second LLM and the human agent are given the same task as the AI agent instead of the evaluation and then their workflow steps and results are compared to determine a confidence level.

In another embodiment, the calibration approach may be used to align LLM, which may be the LLM leveraged by the AI agent, or a group LLMs, as depicted in FIG. 9, that are used by the AI agent to generate the workflow. Such calibration may be based on the human agent's evaluation of the AI Agent's performance. For example, if the AI Agent's result is off by 23% from the human agent, then the calibration may be to calibrate the LLMs leveraged by the AI agent by 23%. Likewise, if the calibration is to use an additional step it in the workflow, reduce a step, use a different tool, or perform a different calculation than what the AI agent did using the LLM, which may be based on the human agent's evaluation, then the LLM may be calibrated to perform the additional step it in the workflow, reduce a step, use a different tool, or perform a different calculation.

In another embodiment, the calibration approach may also be to calibrate LLM 2, the separate LLM that evaluates the AI agent's performance, then use recommendations from the LLM 2 after the calibration to then suggest those recommendations to LLM1 or other LLMs leveraged by the AI agent to generate workflows or directly calibrate LLM, and other LLMS, or the workflows to the human agent's evaluation or performance such that they meet the confidence level of the human agent's evaluation or performance.

The confidence level may include a scale of low, medium, high, a scale of 1-10, with 10 being the highest confidence level, a scale of 1-100, an alphanumeric scale, or any other type of scale. Each second LLM evaluation of the AI agent's performance and result may be compared to the human agent and determined where it falls on the confidence scale. The scale may include a predetermined threshold, such a 7 on a 1-10 scale, or a medium on the low, medium, large scale. The iterative process of the AI agent performing one project after another, where the projects and related workflows may be similar or different, may continue until the threshold confidence level is reached.

If the selective alignment calibration technique is used, which includes selectively calibrating parts or segments of the LLM's evaluation to the human agent's evaluation of the AI agent's workflow execution and response/result archived. If the human agent is provided the same task as the AI agent, and then the workflow used by the human agent and the final response is to be used for calibrating the second LLM, then calibration may be performed selectively to avoid errors, inconsistencies, inaccuracies, and irrelevant portions of the human agent's response. With respect to attaining a confidence level, the process may be iterative with multiple rounds of AI agent completing one project after another, where different workflows may be generated and used by the AI agent, and the evaluation of the AI agent's performance, workflows used, and the response/result by the second LLM may continue to be compared and calibrated to the human agent, except that it may be done selectively to avoid errors, inconsistencies, inaccuracies, and irrelevant portions of the human agent's response.

In each round, if the second LLM's evaluation deviates from the human agent's evaluation, such as by a predetermined threshold, then the second LLM may continue to be calibrated until it aligns more closely with the human agent. By iteratively refining the second LLM's evaluation capabilities, and checking the confidence level with each iteration and further calibrating as needed, the system may continue the process to achieve a high level of confidence or a confidence level that meets or exceeds a confidence threshold.

Likewise, calibration when enhanced alignment or outcome alignment embodiments are used may be performed in a similar manner until the second LLM's performance, evaluation, and results meet or exceed a predetermined confidence threshold.

In some embodiments, the rubric may be determined to be completed for self-evaluation purposes when the confidence level is achieved. Achieving the confidence level may be used as an indication that the second LLM, which is independent from the LLM used by the AI agent, is capable of performing as a human agent or as a human agent without the errors, redundancies, and inconsistencies. Once the rubric is determined to be completed for self-evaluation purposes, the AI agent may self-evaluate its performance, which includes self-evaluating workflows, steps of workflows, results of each step of the workflow, and the final result/response. Although the rubric may be determined to be completed for self-evaluation purposes, it may continue to be updated even after as the AI agent continues to process additional queries and projects.

In some embodiments, the rubric that is ready to be used for self-evaluation by the Agent, e.g., completed based on sampling of projects in the initial sampling when confidence threshold is reached, may include evaluation criteria of how to score and self-evaluate. The evaluation criteria may be a combination of query and instructions, where the instructions relate to the type and nature of the query. The evaluation criteria of the rubric may also provide instructions on how to score the workflow used, steps of the workflow, result from each workflow step and/or the final response/result. For example, the evaluation criteria may provide instructions to add 1 point to the score if the methodology to obtain the final response/result follows the same methodology used by the human agent, add 1 point if the final response/result is formatted according to the rubric, add 1 point if the final response/result includes an explanation, etc. Likewise, it may instruct to subtract points when certain instructions of the rubric are not followed.

In some embodiments, the AI agent may process a user query after the rubric is ready to be used for self-evaluation. In processing the user query, the AI agent may generate one or more workflows and execute one or more of the generated workflows. The AI agent may then obtain the final response/result based on execution of the workflow. The AI agent may use the rubric to self-evaluate the final response/result as well as the workflow and steps of the workflow used to obtain the final response/result. If the AI agent may score the final response/result based on the final response/result's adherence to the rubric. Although each final response/result for each query may be different, the scoring may be related to following the instructions within the rubric. For example, when the AI agent processes a query, the AI agent may self-evaluate, leveraging an LLM whether the instructions in the rubric, which relates to the type of query received for the project, were followed by the AI agent.

The AI agent may score its performance based on the rubric as well as identify any errors, inconsistencies, redundancies, that may be improved based on the self-evaluation. For example, the AI agent, comparing to the rubric and leveraging an LLM, may determine that one of the steps of the workflow has an error which caused the response/result to not be aligned with the rubric. Accordingly, such errors may be identified and the AI agent may self-correct the error and re-run the query to improve its performance.

In some embodiments, the AI agent may compare its performance and results to the rubric by using an LLM. For example, after completing a response to a query or a project, the AI agent, leveraging an LLM, may analyze the workflow used and compare it to the instructions in the rubric. The rubric, which combines the query with specific instructions, may provide instructions on which types of workflows or steps of workflows to be used. It may indicate some steps as mandatory, such as for crucial or foundational steps, while other steps as optional to provide flexibility. The AI agent may use the rubric and leveraging the LLM identify whether the workflows and its steps followed by the AI agent align with the mandatory instructions that relate to workflow steps in the rubric. The AI agent may then provide a score based on the comparison.

In some embodiments, the AI agent may continuously improve its performance by comparing itself to the rubric and performing workflow improvements accordingly. For example, if the AI agent, leveraging the LLM, determines that the workflow, any step of the workflow, or overall result or response falls below a set threshold when compared to the rubric, it may automatically initiate the self-correction process. This self-correction process may involve the AI agent to adjust specific steps of workflow, add new steps, delete steps, replace steps, or use a new workflow entirely. The AI agent may then perform the adjustments and rerun the same project iteration after iteration until a score that exceeds a threshold of adherence to the rubric is obtained.

In some embodiments, an AI agent, leveraging the LLM, may perform several iterations of execution of the query until the result or the workflow used adheres to the rubric beyond a predetermined threshold. In other embodiments, the AI agent, leveraging the LLM, may perform several iterations until a pre-defined counter limit is reached. If the limit is reached and the adherence to the rubric has not exceeded the threshold, then the AI agent may determine that the current workflow or methodology is unsuitable for the query and redesign the workflow in its entirety or use a different methodology to retest its adherence to the rubric.

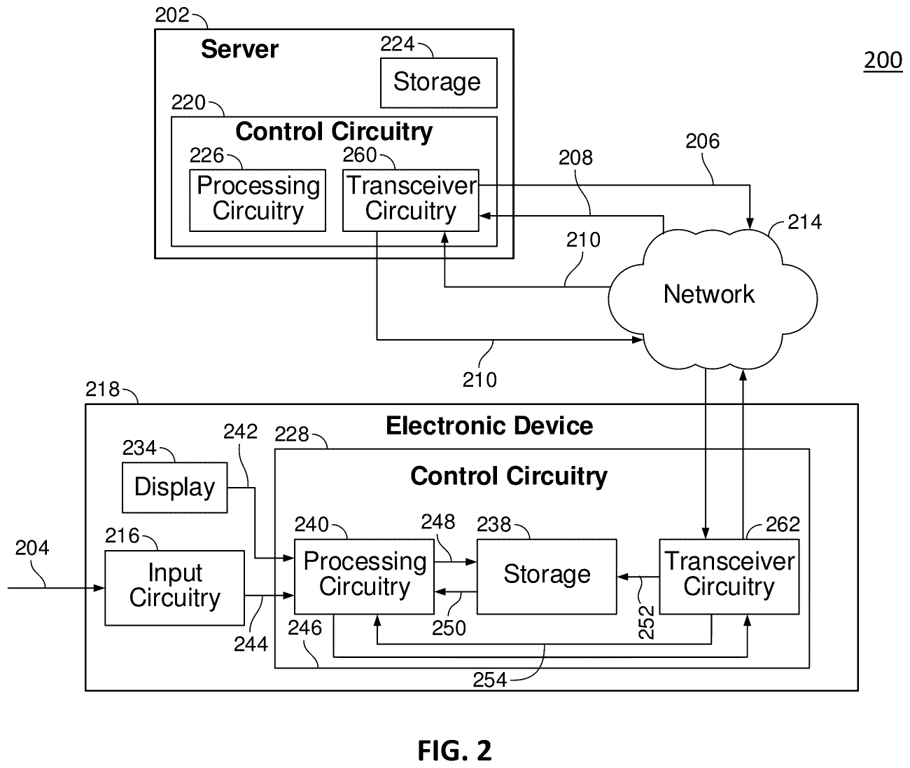

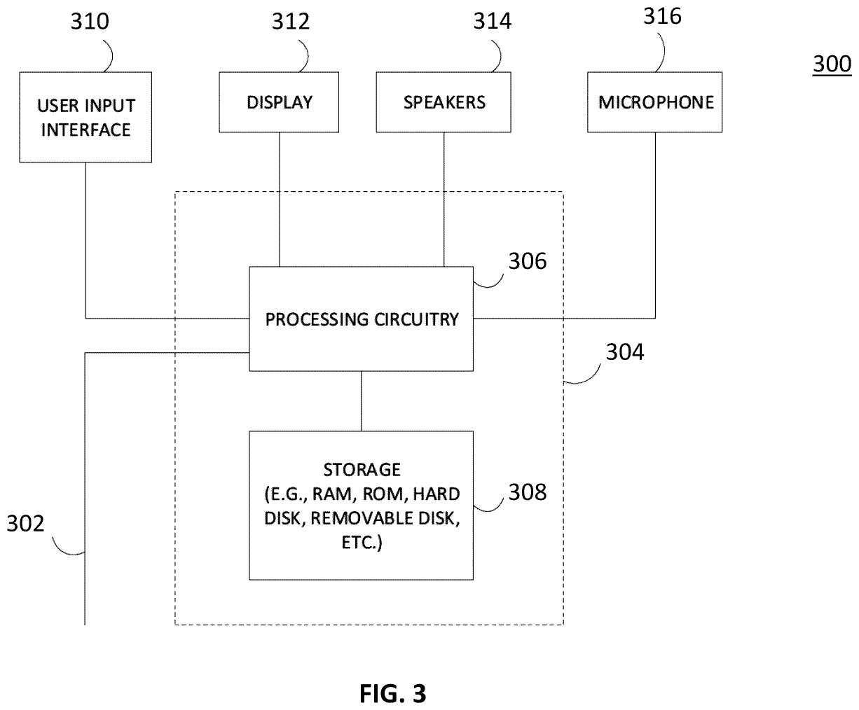

Referring now to the figures, FIG. 1 is a block diagram of a self-evaluation and correction process 100 in an artificial intelligence environment for providing an enhanced outcome, in accordance with some embodiments of the disclosure. The process 100, as depicted in FIG. 1, may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

In some embodiments, the artificial intelligence (AI) agent 105 may receive a query from a user or a project inputted for the AI agent to provide a response, result, a document, or other form of output, such as code. The AI agent may receive a wide range of user queries that may vary from simple requests to complex, multi-part documents, requests to generate code, requests to produce a multi-chapter response to a request for proposal (RFP). When such queries or requests are presented, the AI agent may be tasked with providing responses, results, and answers to them by leveraging an LLM.

In some embodiments, to provide the response, result, and/or answer, leveraging an LLM, the AI agent may generate one or more workflows. An example of a query may be to onboard an employee and the example of the workflow generated may be a workflow that includes multiple steps that check employee background, check employee education and degrees, process orders for getting the employee a new badge and a laptop, a process for providing the new employee access to databases, or setting them up with payroll. To accomplish these tasks and sub-tasks, the AI agent may automatically generate one or more workflows.

In some embodiments, the query may also be an interactive conversation. In such an embodiment, the AI agent may generate each step of the workflow as it learns more from the back-and-forth interactive conversation. Based on the insights gained from these conversations, the AI agent may leverage an LLM to simultaneously generate workflow having multiple steps in real-time.

The AI agent may also analyze the query or request and categorize it into different groups, generating different workflows for each category, which may be a series of nested LLMs, to provide the response.

The AI agent, via the query or request, or by asking further questions may also determine the persona of the user that provided the query. The AI agent may then use the persona to generate responses that are suitable for the determined persona such that the user having the persona can use it for their purpose.

In some embodiments, the AI agent may generate workflows based on the user's department. For example, if the user asking the query is from a finance department, then the persona may be determined and the workflow that can be used by employees in the finance department may be generated.

Once the AI agent 105 automatically, without user intervention, generates the workflows, such as workflows 110-130, the AI may execute one or more of the workflows 110-130 to provide a response to the query. In some embodiments, the AI agent 105 may select one or more workflows, from the number of generated workflows 110-130 based on a ranking. For example, the AI agent may rank generated workflows based on their applicability to the query, accuracy versus cost-efficiency, amount of time taken to obtain an answer, or based on another factor and select the most cost-effective workflow, the most accurate workflow, or follow a criteria on which workflow to select. The AI agent may also process the query using multiple workflows and compare their outputs to determine the best response. In some embodiments, to select a workflow, from the plurality of generated workflows, the AI agent may consider various factors such as time constraints, cost limitations, data accessibility, and data authorization, to select the most suitable workflow that meets the provided criteria for such factors.

Once the workflows are used and executed to obtain a response, the AI agent may engage in a self-evaluation process to assess the quality, relevance, or accuracy of the response as well as the quality, relevance, or accuracy (and other factors) of the workflow used. To perform such a self-evaluation, the AI agent may use a pre-generated rubric 140. The self-evaluation process may be performed by the AI agent, leveraging an LLM, to determine adherence to the rubric. The rubric 140 may be generated based on evaluations, scores, comments, and suggestions from a separate LLM and a human agent based on their evaluation of a sampling of an initial set of projects executed by the AI agent. The rubric 140 may include instructions that are related to different types of queries. The AI agent may leverage an LLM and determine adherence to the query-based instructions in the rubric 140 to determine whether such instructions were followed. The self-evaluation may include evaluating the workflow user, results of the workflow, steps of the workflow and results on a set-by-step basis, adherence to the persona determined, adherence to accuracy or cost, and any other criteria or instructions within the rubric 140. The rubric 140 may be continuously updated to maintain its accuracy and relevance as the AI agent 105 executes each project.

In some embodiments, the AI agent, leveraging an LLM, may determine its adherence to the rubric. Based on the determination, if the workflow used, calculations made, processes executed, or the final result/response for the query does not adhere to the rubric, the AI agent may automatically initiate a self-correction process and make corrections and adjustment to the workflow, steps of workflow, and/or the final results. To do so, the AI agent modifies parameters used in the workflow to the parameters from the rubric.

The AI agent may also, using the rubric, determine if a particular step or calculation made did not adhere to the rubric 160. If an error is found when a step or calculation performed does not adhere to the rubric, then the AI agent may identify the error, such as at 154, and then self-correct by using different techniques, such as a different calculation, adjusting the workflow steps, adding or removing workflow steps, modifying a workflow step, change the methodology, using a different tool to process or perform the workflow step, or implementing other modifications to improve its adherence to the rubric. Accordingly, the AI agent makes the adjustment and rerun the same query/project iteratively until the score (152) indicating adherence meets or exceeds a pre-defined rubric adherence threshold.

FIG. 2 is a block diagram of an example of a system for performing a self-evaluation and self-correction process in an artificial intelligence environment for providing an enhanced outcome, in accordance with some embodiments of the disclosure and FIG. 3 is a block diagram of an example of an electronic device or user device for performing a self-evaluation and self-correction process in an artificial intelligence environment for providing an enhanced outcome, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4A-9. Further, FIGS. 2 and 3 may also be used to generate a rubric based on processing an initial set of workflows. These workflows may be generated by an AI engine leveraging an LLM, such as LLM1, to respond to a query. Data related to the query, the workflows generated and executed, the steps of the workflow, interim results of each step, processes and tools used to execute each step and the final result from one or more workflows processed may all be used for generating the rubric. FIGS. 2 and 3 may also be used to determine a confidence level between the performance level of the AI agent and a human agent for the same of similar query, wherein the confidence level may be measured on a scale to determine whether the AI agent performance exceeds a confidence threshold of how a human agent would have performed given the same query. In other words, FIGS. 2 and 3 may be used to determine whether the workflows generated and executed, the steps of the workflow, interim results of each step, processes and tools used to execute each step and the final result from one or more workflows were executed such that with confidence, such by measuring to a confidence threshold, a determination can be may whether the human agent would have performed the same. FIGS. 2 and 3 may also be used to obtain evaluations of the workflows generated and executed, the steps of the workflow, interim results of each step, processes and tools used to execute each step and the final result from one or more workflows processed by a human agent and a separate LLM, such as LLM2, or a plurality of separate LLMs, that are separate from the LLM1 used by the AI agent to generate the workflows. A determination may be made whether the evaluation of the AI agent's performance, including the AI agent's performance relating to workflows generated and executed, the steps of the workflow, interim results of each step, processes and tools used to execute each step and the final result from one or more workflows, as performed by the separate LLM, such as LLM2, meets a confidence threshold of the evaluation of the AI agent and the processes performed by the AI agent. In other words, is the LLM2's evaluation the same, or same to a threshold level of confidence, as the evaluation by the human agent of the AI Agent's performance. If it is the same, then a determination is made that LLM2 is aligned in its methodology as the human agent and any recommendations provided by LLM2 to LLM1, the AI agent, such as to modify the workflows, would also be aligned with what the human agent would have recommended. FIGS. 2 and 3 may be used to calibrate the AI agent's performance, the LLM used by the AI agent, or the separate LLM2, to the human agent. The calibration may be performed to align the generation, processing, and execution of the workflows such that the interim and/or final results are aligned with the human agent. FIGS. 2 and 3 may be used to determine that the rubric is completed and ready to be used by the AI agent for self-learning, self-evaluation, and self-correction, once a determination is made that the AI agent, the LLM used by the AI agent, and/or the separate LLM, are calibrated such that their performance is within a confidence threshold of the human agent's performance or the human agent's evaluation of their performance. Once the rubric is completed, FIGS. 2 and 3 may be used for processing subsequent queries by the AI Agent without the need for a human or separate LLM's evaluation. In that regard, FIGS. 2 and 3 may be used for the AI agent to use the rubric as a way of self-learning, self-evaluation, and self-correction and determine whether the AI agent's performance adheres to the rubric. FIGS. 2 and 3 may be used to determine the level or degree of adherence between the AI agent's performance and the rubric, and if the performance falls below a predetermined threshold, then the AI agent, using the query and instructions from the rubric, may perform self-corrections to then re-process the query until the AI agent's performance, including the results achieved from the workflows executed, adheres to the rubric above the predetermined threshold. FIGS. 2 and 3 may also be used to continuously improve the AI agent's performance, update the rubric, and utilize LLMs, utilize machine learning and AI algorithms, and perform all embodiments disclosed herein.

In some embodiments, one or more parts of, or the entirety of system 200, may be configured as a system implementing various features, processes, functionalities and components of FIGS. 1 and 4A-9. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. In some embodiments, the system may be a generative artificial intelligence system that leverages LLMs. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 and instead such functionality may be implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as user device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, or any other suitable fixed or removable storage devices, and/or any combination of the same. Each storage 224, 238 may be used to store various types of data (e.g., they can be used to store the AI agent, plurality of LLMs, plurality of workflows, confidence level modules and criteria, one or more rubric, calibration modules, calibration data, user interfaces receiving evaluation data, the received evaluation data, query and instructions including those stored as evaluation criteria in the rubric, a knowledge base, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to the AI agent and its performance, plurality of LLMs, plurality of workflows, confidence levels, calibration, evaluations, query and instructions including those stored as evaluation criteria in the rubric, rubrics, NLP, ML, and AI algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received, such as from an application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to detecting that adherence to a rubric falls below a threshold, the AI agent may use the instructions in the rubric to perform self-corrections without any user intervention. To accomplish this, in one embodiment, the control circuitry 228 may perform the steps of process described at least in any one or more of FIGS. 1, 4A, 5 and 7.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive data such as data relating to the AI agent and its performance, plurality of LLMs, plurality of workflows, confidence levels, calibration, evaluations, query and instructions including those stored as evaluation criteria in the rubric, rubrics, NLP, ML, and AI algorithms.

Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In non-limiting examples, computing device 218 may be a personal computer (PC), a laptop computer, a tablet computer, a personal computer television (PC/TV), a generative AI server, a handheld computer, a mobile telephone, a smartphone, or any other device, computing equipment, or wireless device, and/or combination thereof that can receive conversation inputs and process them to generate workflows as discussed.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors or Nvidia processors) or multiple different processors (e.g., an Intel Core i7 and i9 processors or Nvidia GH 100, 200).

In some embodiments, control circuitry 220 and/or control circuitry 218 are configured to generate a rubric based on processing an initial set of workflows. These workflows may be generated by an AI engine leveraging an LLM, such as LLM1, to respond to a query. Data related to the query, the workflows generated and executed, the steps of the workflow, interim results of each step, processes and tools used to execute each step and the final result from one or more workflows processed may all be used for generating the rubric. The control circuitry 218 may also be configured to determine a confidence level between the performance level of the AI agent and a human agent for the same of similar query, wherein the confidence level may be measured on a scale to determine whether the AI agent performance exceeds a confidence threshold of how a human agent would have performed given the same query. In other words, the control circuitry 218 may also be configured to determine whether the workflows generated and executed, the steps of the workflow, interim results of each step, processes and tools used to execute each step and the final result from one or more workflows were executed such that with confidence, such by measuring to a confidence threshold, a determination can be may whether the human agent would have performed the same. The control circuitry 218 may also be configured obtain evaluations of the workflows generated and executed, the steps of the workflow, interim results of each step, processes and tools used to execute each step and the final result from one or more workflows processed by a human agent and a separate LLM, such as LLM2, or a plurality of separate LLMs, that are separate from the LLM1 used by the AI agent to generate the workflows. A determination may be made whether the evaluation of the AI agent's performance, including the AI agent's performance relating to workflows generated and executed, the steps of the workflow, interim results of each step, processes and tools used to execute each step and the final result from one or more workflows, as performed by the separate LLM, such as LLM2, meets a confidence threshold of the evaluation of the AI agent and the processes performed by the AI agent. In other words, is the LLM2's evaluation the same, or same to a threshold level of confidence, as the evaluation by the human agent of the AI Agent's performance. If it is the same, then a determination is made that LLM2 is aligned in its methodology as the human agent and any recommendations provided by LLM2 to LLM1, the AI agent, such as to modify the workflows, would also be aligned with what the human agent would have recommended. The control circuitry 218 may also be configured to calibrate the AI agent's performance, the LLM used by the AI agent, or the separate LLM2, to the human agent. The calibration may be performed to align the generation, processing, and execution of the workflows such that the interim and/or final results are aligned with the human agent. The control circuitry 218 may also be configured to determine that the rubric is completed and ready to be used by the AI agent for self-learning, self-evaluation, and self-correction, once a determination is made that the AI agent, the LLM used by the AI agent, and/or the separate LLM, are calibrated such that their performance is within a confidence threshold of the human agent's performance or the human agent's evaluation of their performance. Once the rubric is completed, the control circuitry 218 may also be configured to allow the AI agent to process subsequent queries by the AI agent without the need for a human or separate LLM's evaluation. In that regard, The control circuitry 218 may also be configured to allow the AI agent to use the rubric as a way of self-learning, self-evaluation, and self-correction and determine whether the AI agent's performance adheres to the rubric. The control circuitry 218 may also be configured to determine the level or degree of adherence between the AI agent's performance and the rubric, and if the performance falls below a predetermined threshold, then the AI agent, using the query and instructions from the rubric, may perform self-corrections to then re-process the query until the AI agent's performance, including the results achieved from the workflows executed, adheres to the rubric above the predetermined threshold. The control circuitry 218 may also be configured to continuously improve the AI agent's performance, update the rubric, and utilize LLMs, utilize machine learning and AI algorithms, and perform all embodiments disclosed herein. Control circuitry 220 and/or control circuitry 218 are also configured to perform all processes and features described and shown in connection with FIGS. 1, 4A-9.

Computing device 218 receives a user input 204 at input circuitry 216. For example, computing device 218 may receive a user input like “Use obtained data from first/next evaluation to generate/update rubric,” as depicted at 740 in FIG. 7.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4A, and 17, respectively.

FIG. 3 is a block diagram of an example of an electronic device or user device for performing a self-evaluation and self-correction process in an artificial intelligence environment for providing an enhanced outcome, in accordance with some embodiments of the disclosure.

The electronic device 300, in some embodiments, may also be used to generate a rubric based on processing an initial set of workflows. These workflows may be generated by an AI engine leveraging an LLM, such as LLM1, to respond to a query. Data related to the query, the workflows generated and executed, the steps of the workflow, interim results of each step, processes and tools used to execute each step and the final result from one or more workflows processed may all be used for generating the rubric. The electronic device 300 may also be used to determine a confidence level between the performance level of the AI agent and a human agent for the same of similar query, wherein the confidence level may be measured on a scale to determine whether the AI agent performance exceeds a confidence threshold of how a human agent would have performed given the same query. In other words, the electronic device 300 may be used to determine whether the workflows generated and executed, the steps of the workflow, interim results of each step, processes and tools used to execute each step and the final result from one or more workflows were executed such that with confidence, such by measuring to a confidence threshold, a determination can be may whether the human agent would have performed the same. The electronic device 300 may also be used to obtain evaluations of the workflows generated and executed, the steps of the workflow, interim results of each step, processes and tools used to execute each step and the final result from one or more workflows processed by a human agent and a separate LLM, such as LLM2, or a plurality of separate LLMs, that are separate from the LLM1 used by the AI agent to generate the workflows. A determination may be made whether the evaluation of the AI agent's performance, including the AI agent's performance relating to workflows generated and executed, the steps of the workflow, interim results of each step, processes and tools used to execute each step and the final result from one or more workflows, as performed by the separate LLM, such as LLM2, meets a confidence threshold of the evaluation of the AI agent and the processes performed by the AI agent. In other words, is the LLM2's evaluation the same, or same to a threshold level of confidence, as the evaluation by the human agent of the AI Agent's performance. If it is the same, then a determination is made that LLM2 is aligned in its methodology as the human agent and any recommendations provided by LLM2 to LLM1, the AI agent, such as to modify the workflows, would also be aligned with what the human agent would have recommended. The electronic device 300 may be used to calibrate the AI agent's performance, the LLM used by the AI agent, or the separate LLM2, to the human agent. The calibration may be performed to align the generation, processing, and execution of the workflows such that the interim and/or final results are aligned with the human agent. The electronic device 300 may be used to determine that the rubric is completed and ready to be used by the AI agent for self-learning, self-evaluation, and self-correction, once a determination is made that the AI agent, the LLM used by the AI agent, and/or the separate LLM, are calibrated such that their performance is within a confidence threshold of the human agent's performance or the human agent's evaluation of their performance. Once the rubric is completed, the electronic device 300 may be used for processing subsequent queries by the AI agent without the need for a human or separate LLM's evaluation. In that regard, the electronic device 300 may be used for the AI agent to use the rubric as a way of self-learning, self-evaluation, and self-correction and determine whether the AI agent's performance adheres to the rubric. The electronic device 300 may be used to determine the level or degree of adherence between the AI agent's performance and the rubric, and if the performance falls below a predetermined threshold, then the AI agent, using the query and instructions from the rubric, may perform self-corrections to then re-process the query until the AI agent's performance, including the results achieved from the workflows executed, adheres to the rubric above the predetermined threshold. The electronic device 300 may also be used to continuously improve the AI agent's performance, update the rubric, and utilize LLMs, utilize machine learning and AI algorithms, and perform all embodiments disclosed herein.

In an embodiment, the equipment device 300, is the same equipment device 202 of FIG. 2. The equipment device 300 may receive content and data via input/output (I/O) path 302. The I/O path 302 may provide audio content and data to control circuitry 304, which includes processing circuitry 306 and storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 or Nvidia processors) or multiple different processors (e.g., an Intel Core i5, i7, i9 processor, Nvidia GH 100, 200).

The processes as described herein may be implemented in or supported by any suitable software, hardware, or combination thereof. They may also be implemented on user equipment, on remote servers, or across both.

In client-server-based embodiments, the control circuitry 304 may include communications circuitry suitable to generate a rubric based on processing an initial set of workflows. These workflows may be generated by an AI engine leveraging an LLM, such as LLM1, to respond to a query. Data related to the query, the workflows generated and executed, the steps of the workflow, interim results of each step, processes and tools used to execute each step and the final result from one or more workflows processed may all be used for generating the rubric. The communications circuitry may also be used to determine a confidence level between the performance level of the AI agent and a human agent for the same of similar query, wherein the confidence level may be measured on a scale to determine whether the AI agent performance exceeds a confidence threshold of how a human agent would have performed given the same query. In other words, the communications circuitry may be used to determine whether the workflows generated and executed, the steps of the workflow, interim results of each step, processes and tools used to execute each step and the final result from one or more workflows were executed such that with confidence, such by measuring to a confidence threshold, a determination can be may whether the human agent would have performed the same. The communications circuitry may also be used to obtain evaluations of the workflows generated and executed, the steps of the workflow, interim results of each step, processes and tools used to execute each step and the final result from one or more workflows processed by a human agent and a separate LLM, such as LLM2, or a plurality of separate LLMs, that are separate from the LLM1 used by the AI agent to generate the workflows. A determination may be made whether the evaluation of the AI agent's performance, including the AI agent's performance relating to workflows generated and executed, the steps of the workflow, interim results of each step, processes and tools used to execute each step and the final result from one or more workflows, as performed by the separate LLM, such as LLM2, meets a confidence threshold of the evaluation of the AI agent and the processes performed by the AI agent. In other words, is the LLM2's evaluation the same, or same to a threshold level of confidence, as the evaluation by the human agent of the AI Agent's performance. If it is the same, then a determination is made that LLM2 is aligned in its methodology as the human agent and any recommendations provided by LLM2 to LLM1, the AI agent, such as to modify the workflows, would also be aligned with what the human agent would have recommended. The communications circuitry may be used to calibrate the AI agent's performance, the LLM used by the AI agent, or the separate LLM2, to the human agent. The calibration may be performed to align the generation, processing, and execution of the workflows such that the interim and/or final results are aligned with the human agent. The communications circuitry may be used to determine that the rubric is completed and ready to be used by the AI agent for self-learning, self-evaluation, and self-correction, once a determination is made that the AI agent, the LLM used by the AI agent, and/or the separate LLM, are calibrated such that their performance is within a confidence threshold of the human agent's performance or the human agent's evaluation of their performance. Once the rubric is completed, the communications circuitry may be used for processing subsequent queries by the AI Agent without the need for a human or separate LLM's evaluation. In that regard, the communications circuitry may be used for the AI agent to use the rubric as a way of self-learning, self-evaluation, and self-correction and determine whether the AI agent's performance adheres to the rubric. The communications circuitry may be used to determine the level or degree of adherence between the AI agent's performance and the rubric, and if the performance falls below a predetermined threshold, then the AI agent, using the query and instructions from the rubric, may perform self-corrections to then re-process the query until the AI agent's performance, including the results achieved from the workflows executed, adheres to the rubric above the predetermined threshold. The communications circuitry may also be used to continuously improve the AI agent's performance, update the rubric, and utilize LLMs, utilize machine learning and AI algorithms, and perform all embodiments disclosed herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store the AI agent, plurality of LLMs, plurality of workflows, confidence level modules and criteria, one or more rubric, calibration modules, calibration data, user interfaces receiving evaluation data, the received evaluation data, query and instructions including those stored as evaluation criteria in the rubric, a knowledge base, and NLP, ML, and AI algorithms. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The microphone 316 may be used by control circuitry 304 to receive audio input. The microphone 316 may be any microphone (or microphones) capable of detecting human speech, such as a speech by a human to evaluate the AI agent's performance. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to performance by the AI agent, leveraging and executing of LLM models, implementing machine learning (ML) and artificial intelligence (AI) algorithms, and all the functionalities discussed associated with the figures mentioned in this application

The electronic device 300 of any other type of suitable user equipment may also be used to implement ML and AI algorithms, and related functions and processes as described herein. Various network configurations of devices may be implemented and are discussed in more detail below.

FIG. 4A is flowchart of an example for generating a rubric used in the self-evaluation and correction process in the artificial intelligence environment, in accordance with some embodiments of the disclosure. The flowchart, which depicts a process 400, may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the method 400.

In some embodiments, an AI agent 410 may receive a user query and in response to the query generates multiple workflows to answer the query. These workflows may be analogues to different ways to solve a problem. Such workflows may be generated based on the AI agent 410 leveraging an LLM.

Although a user query is described, the input to the AI agent may be in many forms. For example, the AI agent 410 may receive a document as input and be prompted to edit the document. Accordingly, the AI agent may generate a plurality of workflows that may have different editing approaches. Other types of input may include coding tasks or any other type of request. Each workflow generated by the AI agent 410 may include a plurality of steps. These steps may follow a simple sequence or in other embodiments be complex similar to several branches of a tree.

Once one or more workflows are generated, in some embodiments, the AI agent may select one or more workflows to answer the user's query or provide a response in the format requested, such as an email, a document, a report, an excel sheet with calculations, a full comprehensive document, such as a response to a request for proposal, or a story with chapters for a book. In some embodiments, the AI agent may select the single workflow from the multiple workflows generated, based on factors such as the workflow's suitability for the task or historical usage within the corporation or one of the workflows. In other embodiments, the AI agent processes multiple workflows, compares the generated responses from the multiple workflows, and then selects the most accurate or relevant response.

Each iteration 420 that the AI agent executes, i.e., each iteration that the workflow(s) are processed to obtain the response/result, data relating to the workflow overall, the steps of the workflow used, each interim result from each step of the workflow, and the final response/result may be fed into the rubric 440.

In some embodiment, the AI agent 410 executes a first iteration of processing the workflows generated to get the result/response. As described earlier, the data relating to the first iteration of the workflow, the steps of the workflow used, each interim result from each step of the workflow, and the final response/result for the first iteration is inputted into the rubric. The data from the first iteration is also evaluated by an evaluation system 430, which includes an evaluation by LLM2 and a human evaluation.

In some embodiments, two approaches may be used to evaluate an AI agent's performance. The first approach may involve both LLM2 and a human agent. In this embodiment, LLM2 may analyze the AI agent's performance, including the workflows generated, steps of the workflow, intermediate results, and final outcome. LLM2 may then calculate a score based on its own training data and benchmarks for the AI agent's performance, including the granular steps and processes performed. The human agent may also score the AI agent's performance based on whether they would have taken similar steps and achieved the similar results. In addition to scoring, both LLM2 and the human agent may provide feedback on any aspect of the agent's process.

In another embodiment, the second evaluation approach may be a blind approach. In this embodiment, LLM2 and the human agent may receive the same query as the AI agent 410, but without any knowledge of the AI agent's workflow or results. LLM2 and the human agent may then independently generate their own solutions and workflows based on their respective training data or experience. Once the LLM2 and the human agent have completed their workflows, their workflows, and results, may be compared with the AI agent's performance and results by a third or independent LLM. This third or independent LLM may then score the AI agent's performance based on how well the AI agent's performance aligns with LLM and/or human agent's performance. Although two approaches of evaluations have been described, the embodiments are not so limited and evaluations may use other approaches, such as combining LLMs, human experts, or even domain-specific LLMs to create a more comprehensive assessment of the AI agent's performance.

In some embodiments, once the AI agent's performance is evaluated by both the LLM2 and the human agent. As described earlier, this evaluation may include scoring and feedback of the AI agent's overall performance as well as evaluating each granular step, process, and workflow generated and executed by the AI agent 410 to generate the response to the query.

In some embodiments, a goal may be to align the LLM2's evaluation of the AI agent with the human agent's evaluation. The goal may be for LLM2 to act in the place of the human agent with a high degree of matching how the human agent would think and evaluate the AI agent's performance.

A confidence level, which may be measured on a scale (e.g., 0-100, 1-1000, or categorical), may be used to determine how closely the LLM2's evaluated matches the human agent's evaluation. A perfect match would result in a 100% confidence level.

If the LLM2's evaluation falls below a predefined confidence threshold, which would mean that LLM2 is capable of guiding and evaluating the AI agent's performance to a higher degree like a human would do, the LLMs may be calibrated based on the human agent's scores and feedback of the AI agent. This calibration may involve adjusting the LLM2's parameters or training data to improve its ability to assess the AI agent's performance closer to what the human agent would do.

In some embodiments, the LLM2's evaluation of the AI agent 410 as compared to the human agent's evaluation of the AI agent may fall below a pre-determined confidence threshold. In this circumstance, the LLM2 may be calibrated based on the human's evaluation of the AI agent. This step may be to train LLM2 to learn and improve such that LLM2 can also evaluate the performance of the AI agent like the human agent would do. Based on the evaluation, such as the human's evaluation of the AI agent, if that falls below the threshold, e.g., the AI agent has not performed similar to the human, then feedback data and scores, which may be analyzed by LL2, may be inputted into the AI agent as feedback for improving its performance such that it can perform closer to the human agent.

The process described may accomplish two milestones. First the AI agent may perform aligned with the human agent, at least above a confidence threshold and second, the LLM2 may be trained to evaluate like the human agent would evaluate the AI agent's performance. Once the AI agent has performed aligned with the human agent, having gone through iterations and such data inputted into the rubric, a determination may be made that the AI agent has been fine-tuned to the human agent. The rubric may also be completed to keep the AI agent fine-tuned to the human agent's performance and no longer needs the human to continue to evaluate the AI agent since the AI agent may now be able to rely on the rubric.

In some embodiments, with this new information, the AI agent may modify its workflows and re-execute them. The result and response may then be fed back into the evaluation system, starting a new iteration. This cycle may continue until a) the LLM2's evaluation aligns with the human's agent and b) the AI agent performance surpasses a confidence threshold that indicates that the AI agent can perform aligned with the human agent to a higher degree. Once this benchmark is achieved, the “rubric” for evaluation can be considered complete for the AI agent. Through these iterations, the institutional knowledge may be included in the rubric in form of query and instructions that may be used by the AI agent to self-evaluate, self-guide, and self-correct itself using the rubric.

FIG. 4B is an example of a system for generating a rubric used in the self-evaluation and self-correction process in the artificial intelligence environment, in accordance with some embodiments of the disclosure.

In some embodiments, the AI Agent may be an orchestrator of the entire system, generating and executing workflows, evaluating their performance, and calibrating them based on rubrics. It may self-learn, self-evaluate, correct its own mistakes, and conduct various forms of self-corrections.

In some embodiments, in its initial phase of generating the rubric, the AI system may interact with various components, 472-482 to generate the rubric. As mentioned earlier, the components 472-482 may be separate or combined in one or more systems.

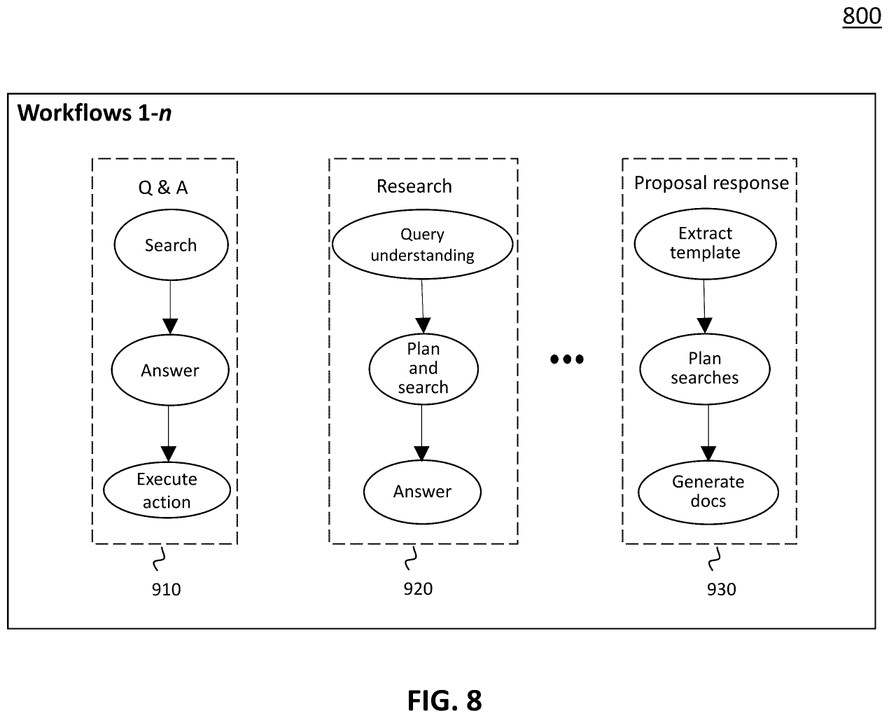

In some embodiments, the workflow generator 472 may generate workflows, including those illustrated in FIGS. 1 and 8. It may utilize LLM 1 474 to generate these workflows. When the AI agent receives a query, it may invoke the workflow generator 472, which leverages LLM 1 to create the workflows to address the query. In some embodiments, LLM 1, as previously discussed, may either be integrated into the workflow generator 472 or exist as a separate component connected to the workflow generator 472 via Network 470. LLM 1 may consist of a single language model or a complex network of multiple LLMs, each specializing in different domains and methodologies, as depicted in FIG. 9. This hierarchical structure of LLMS may allow for a more nuanced and tailored approach to generating workflows that may be specialized, domain specific, methodology specific, enterprise department specific, and employee skill set or employee authorized databases specific.

In some embodiments, the evaluation system 476 may include a confidence level evaluator 478, either as an integrated component or a separate module or system connected via network 470. The evaluation system 476 may incorporate evaluations from LLM 2 and human agent, as depicted at 430 in FIG. 4A. The confidence level evaluator 478 assesses the AI Agent's performance against human agent or the human agent's evaluation of the AI agent, determining whether it meets specific confidence criteria or thresholds. In other embodiments, the confidence level evaluator may compare LLM 2's evaluation of the AI Agent to a human agent's evaluation of AI agent, ensuring alignment in evaluations.

In some embodiments, the calibrator 480 may be integrated into the evaluation system 476 or function as a separate component and interact via network 470. The calibrator 480 may play various roles in refining the AI Agent's performance or evaluation of AI Agent's performance which may lead to calibration that may refine the AI agent's performance. In one embodiment, it may calibrate the evaluations of separate LLMs, such as LLM 2, to align with human agent's evaluations. In another embodiment, the calibrator 480 may directly calibrate LLM1 based on suggestions from LLM2, ensuring that subsequent workflow executions are more aligned with the human agent. In yet other embodiments, the calibrator 480 may directly calibrate the workflows generated by the workflow generator 472, to improve the AI Agent's responses and better align them with human agent's workflows, responses, and evaluations. In yet other embodiments, once LLM2 is calibrated, the recommendation is may provide the AI agent or LLM1 may be based on the calibration and result in a workflow execution and result that is more aligned with the human agent, at least above a confidence threshold. If not aligned, then another calibration may be performed for LLM2 and LLM2 may provide recommendations based on the subsequent calibration.

In some embodiments, the rubric generator 482, may be connected to other components via network 470 and be able to generate one or more rubrics based on the AI Agent's performance. By analyzing multiple iterations of the AI Agent's workflow executions, evaluations, and calibrations, the rubric generator may create and update rubrics. This iterative process may allow for continuous improvement in the AI Agent's performance, as the rubrics evolve to reflect the evolving standards and expectations until the confidence level that the AI agent's performance exceeds a confidence threshold criterion of the human agent is satisfied.

In some embodiments, the rubric adherence evaluator 484, connected to other components via network 470, may be used to determine whether the AI agent's performance adheres to the rubric generated by the rubric generator 482. Once a rubric is established for self-evaluation, self-correction purposes, the evaluation system 476 may not be used as the AI Agent may be able to independently assess and correct its performance based on the rubric. The rubric adherence evaluator 484 may compare the AI Agent's performance, which includes all aspects of the performance, including the workflow execution and final results, identifying areas where the AI Agent may deviate from the desired standards. By iteratively refining its performance based on rubric adherence, the AI Agent may be able to perform self-learning, self-evaluation and self-correction.

FIG. 5 is an example of a user interface used by a human agent to score and evaluate an AI agent's performance, in accordance with some embodiments of the disclosure. In some embodiments, a system, such as the system in FIG. 2, may display a user interface 500 to the human agent that can be used by the human agent for evaluating the AI agent's performance. The user interface 500, in one embodiment, may include a section 510 for displaying the workflow used by the AI agent to respond to the query as well as the interim and final results of the workflow used. The user interface 500, in one embodiment, may also include a section 520 which can be used by the human agent to evaluate the AI agent's performance.

Using this user interface 500, the human agent may evaluate the entire workflow, individual steps of the workflow as they progress, each workflow step's results, or the final result or response to the query produced by the AI agent by processing the workflow. In some embodiments, the workflow may be displayed live on the human agent's interface, allowing real-time monitoring, evaluation, and feedback by the human agent as the workflow progresses from one step to the next and before the workflow is completed.

In some embodiments, the evaluation may be provided by the human agent throughout the workflow, not just after completion. The human agent may provide scores and feedback as the AI agent progresses through the workflow.

In some embodiments, when the human agent provides evaluation during the progress of the workflow, such as feedback, comments, suggestions, or scores, such feedback may be incorporated in real-time thereby allowing the AI agent to adjust its course in real-time. Such live interaction may lead to results and processes that are more aligned with the human agent increasing the probability of a higher confidence score as compared to waiting for the final outcome and then course correcting and calibrating. Both approaches, which provide evaluation after the completion and during the progression are contemplated within the embodiments. Furthermore, as described earlier a blind evaluation where the human agent is provided the same query as the AI agent and then the AI agent and the human agent's workflows and results are evaluated by a third LLM are also contemplated.

In yet other embodiments, in a setting where the LLM2 and/or the human agent may evaluate the AI agent during the progression of the workflow, the AI agent may monitor live evaluation by LLM 2 from FIG. 4A and the human agent and automatically calibrate the LLM leveraged by the AI agent during the progression of the workflows based on the evaluation provided. All the data relating to the evaluations, course corrections, and calibrations, may be fed into the rubric, which may later be used by the AI agent to perform self-evaluation, self-correction, and self-learning. All such self-evaluation, self-correction, and self-learning data may also be fed into the rubric, which is continuously updated with each query responded to by the AI agent.

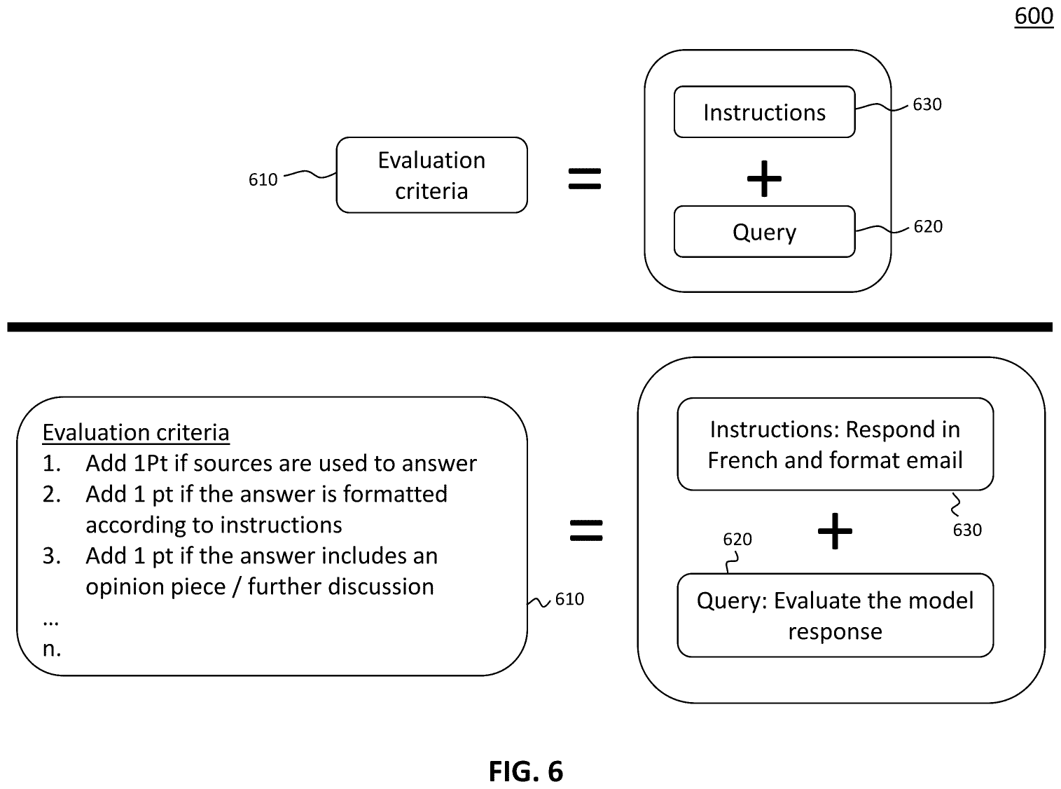

FIG. 6 is an example of components of a rubric, in accordance with some embodiments of the disclosure. In some embodiments the rubric may include an evaluation criterion 610 which may be based on the query 620 and related instructions 630.

In some embodiments, the rubric generated may be a dynamic rubric that may be used for evaluating an AI agent's performance. As the AI processes each query, the rubric may learn from both the content of the query, the workflow used to answer it, the results of the workflow, and an evaluation of the AI agent's performance, including all workflows and results, by the separate LLM and the human agent. This information may be inputted into the rubric for constantly refining its evaluation criteria.

In some embodiments, both separate LLM and human agent may evaluate the AI's performance. Such evaluation and related feedback and scoring may also be used as feedback to derive instructions for the queries. These instructions may then be integrated into the rubric associated with that specific query such that when a future query matches some portions of the query, associated instructions may be used for the AI agent to self-learn, self-evaluate, and self-correct.

In some embodiments, the continuous learning process may ensure that the rubric stays relevant and is updated. As the AI encounters various queries and undergoes iterations, including modifications to the initial query, each iteration and modification may also be inputted into the rubric. As such, the rubric may also be updated through the iterations and query modifications.

Once the rubric is completed, e.g., after an initial number of queries and projects by the AI agent have been processed and the calibrations have exceeded the confidence threshold of a human evaluation, then the rubric may be determined to be ready for the AI agent to use to self-learn, self-evaluate, and self-correct. At this stage, when the AI agent receives a user query, it may look up for corresponding instructions in the rubric. These instructions may then be by the AI agent to self-evaluate its performance related to the query received and deploy self-correction measures.

In some embodiments, the rubric can also define a scoring system. This scoring system may assign points based on how well the AI's performance adheres or aligns with different parameters of the rubric. For example, a specific query and instruction set may have a maximum score of 5 points. If the AI agent performs perfectly, achieving all 5 points, it demonstrates 100% adherence to the rubric. Conversely, a score of 3 out of 5 may indicate acceptable performance if that's the minimum passing score or threshold set for that particular query in the rubric. Accordingly, the rubric may serve as a dynamic and adaptable system, guide, template for the AI agent to self-learn, self-evaluate, and self-correct.

FIG. 7 is flowchart of a process 700 for generating and updating the rubric based on confidence level, in accordance with some embodiments of the disclosure. The process 700 may be implemented, in whole or in part, by systems or devices such as those shown in FIGS. 2-3. One or more actions of the process 700 may be incorporated into or combined with one or more actions of any other process or embodiments described herein. The process 700 may be saved to a memory or storage (e.g., any one of those depicted in FIGS. 2-3) as one or more instructions or routines that may be executed by a corresponding device or system to implement the method 700.

In some embodiments, the AI agent may receive a query and in order to respond to the query, it may leverage an LLM and generate one or more workflows. Once one or more workflows are generated, in some embodiments, the AI agent may select one or more workflows to answer the user's query or provide a response in the format requested, such as an email, a document, a report, an excel sheet with calculations, a full comprehensive document, such as a response to a request for proposal, or a story with chapters for a book. The AI agent may then process the workflow and obtain the result/response to the query.

At block 710, once the AI agent processes the workflow, the AI agent's performance data is obtained. At block 720, the AI agent's performance, encompassing the workflow, its steps, and all generated results, may be evaluated by a separate LLM, such as LLM 2 in FIG. 4A and a human agent. In some embodiments, the evaluation may be performed simultaneously. The evaluation may include comments, feedback, and scores and feedback on various aspects of the AI agent's performance.

At block 730, the data from the evaluation may be obtained. In one embodiment, the evaluation data from the separate LLM may be compared to the evaluation data from the human agent. This comparative analysis may be performed to determine if the separate LLM evaluates the AI agent's performance similarity to the human agent's evaluation of the AI agent's performance. At block 750, if a determination is made that the separate LLM evaluates the AI agent's performance the same as the human agent, it will be likely because the AI agent also uses similar methodology or workflows as the human agent. If it does evaluate to surpass a predefined confidence threshold, then the rubric, which is fed all the data from the AI agent and the evaluation, may be determined to be completed for the purposes of self-evaluation use by the AI agent.

However, at block 750, if a determination is made that the evaluations fail to meet or exceed the confidence threshold, the process can be iterated a specified number of times. A counter may keep a limit of the number of times the loop has been performed. However, if the limit is reached at the counter and the evaluations still fall short of the threshold, an alternative approach may be determined.

This valuable evaluation data, comprising scores, comments, and feedback from both the separate LLM and human agent, is inputted into the rubric. The rubric's input may also incorporate information about the query type and any relevant instructions or feedback provided for that specific query by the separate LLM and the human agent.

Although block 750 discusses similarity between the separate LLM and the human agent, it may also be used to determine similarity of workflow and results of the LLM leveraged by the AI agent and the human agent. An assessment may be made by yet another separate LLM whether the LLM leveraged by the AI agent performs in a manner similar to the human agent to the extent it surpasses a confidence threshold.

Once the rubric is finalized, it becomes a valuable tool for the AI agent's self-evaluation, self-learning, and self-correction processes. As explained earlier, the goal may not be to copy the human agent, but for the AI agent to develop similar skill, judgement, and methodology to then be able to answer queries, solve problems, and generate a document like a human would have the intellect to do. Accordingly, the rubric may provide the framework for the AI agent to perform as such.

FIG. 9 is an example of a plurality of workflows generated by the AI agent, in accordance with some embodiments of the disclosure. In some embodiments, the AI agent to respond to a query may generate one or more workflows, such as workflows 910-930 or 1-n number of workflows. These workflows can take various forms and use different methodologies to respond to the query. For example, workflow 910 may involve a question-and-answer methodology. In this embodiment, the workflow may include steps that conduct searches based on the user's query and provide answers. Additionally, actions may be executed based on the answers provided.

In some embodiments, another potential workflow that may be generated may be workflow 920, which may be research oriented. In this workflow, the steps of the workflow may be designed to first try to understand what kind of output the user desires for their query and then plan and conduct searches based on this understanding and finally present the answer.

In yet other embodiments, the AI agent may generate workflow 930. This workflow 930 may be to respond to request for proposal (RFP). This workflow might utilize a pre-defined RFP template with various sections that can be filled based on the user's query. For example, if the user requests a proposal document, the AI agent may generate this workflow which may have steps to extract relevant sections from a pre-existing template and populate them with information retrieved through searches. This workflow may involve planning the type of searches needed for each section, filling the template sections, and finally generating the proposal document.

Although a few workflow examples have been described, the embodiments are not so limited. The AI agent may generate any type and number of workflows to respond to the query. In some embodiments, once a plurality of workflows is generated, the AI agent may consider various factors about the user who submitted the query to narrow it down to a smaller set of workflows that can be used for processing the query. These factors may include the user's job title, skill set, and department within the company. By considering these factors, the AI agent may distill down the available workflows and select one or more that are most suitable for the user's capabilities and role.

In some cases, the AI agent may generate multiple sets of workflows where each workflow depends on another. This may involve a step from one workflow relying on a second workflow. In some embodiments, a step of the workflow may be to use external tools through API calls to obtain specific results for that particular step.

FIG. 9 is an example of a plurality of LLMs that may be used to generate workflows and perform rubric based self-evaluation and self-correction, in accordance with some embodiments of the disclosure.

In some embodiments, the AI Agent may use a router to prioritize and select appropriate LLMs for specific queries. For example, the AI agent may select a first router which may connect to LLM A or LLM B and/or a second router, which may be connected to the first router, to provide access to LLMs E-F. The hierarchical approach may allow the AI Agent to efficiently leverage multiple LLMs with specialized expertise based on selection factors, enabling it to generate more accurate and comprehensive responses.

The AI Agent can select LLMs based on various factors, including their domain expertise, methodologies, training data, and the specific department or authorization level of the query. For example, a finance employee might pose a query related to financial data. The AI Agent would then route the query to an LLM specializing in financial data, ensuring that the employee has the necessary authorization to access such sensitive information. Conversely, if another LLM contained highly confidential financial data restricted to the executive department, the AI Agent would not select that LLM to protect the confidentiality and privileged nature of the data. This flexibility allows the AI Agent to tailor its responses to the unique needs of each user and query. The LLMs may be organized in a hierarchical or networked structure, enabling the AI Agent to efficiently combine the strengths of multiple models and relevant data from relevant LLMS to generate comprehensive, relevant, and accurate responses to queries.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A self-learning method for an artificial intelligence (AI) agent comprising:
generating, by the AI agent, a workflow for responding to a query, wherein the workflow is generated leveraging a first LLM;
executing the generated workflow by the AI agent using the first LLM to obtain a response to the query;
calibrating the workflow based on an evaluation of the execution of the generated workflow by the AI agent from a human agent;
generating a rubric that includes data from the execution of the workflow and the calibration; and
determining adherence to the generated rubric for a subsequent workflow executed by the AI agent.

2. The method of claim 1, further comprising:
determining that the subsequent workflow executed by the AI agent does not adhere to the generated rubric; and
in response to the determining that the subsequent workflow executed by the AI agent does not adhere to the generated rubric, using parameters from the rubric to execute a self-correction process, wherein the self-correction process includes re-executing the workflow by modifying parameters used in the workflow to the parameters from the rubric.

3. The method of claim 1, wherein calibrating the workflow includes adding a workflow step, removing a workflow step, modifying a workflow step, or using a different tool to perform the workflow step.

4. The method of claim 1, further comprising, calibrating the workflow based on an evaluation from a second LLM, wherein the second LLM being a separate LLM than the first LLM.

5. The method of claim 1, wherein determining adherence to the generated rubric for the subsequent workflow executed by the AI agent is performed by the AI agent independently by referencing the AI agent's performance to the generated rubric.

6. The method of claim 5, further comprising, determining the adherence to the generated rubric after the generated rubric is ready to be used for self-evaluation by the AI agent, wherein the rubric is determined to be ready for self-evaluation by the AI agent when the response to the query exceeds an associated confidence threshold.

7. The method of claim 6, wherein the response to the query exceeds the confidence threshold if a determination is made that the response to the query, obtained by the AI agent by executing the workflow, exceeds a human agent's evaluation of the response above a threshold.

8. A method for an artificial intelligence (AI) agent to perform self-evaluation and self-correction comprising:
generating, by the AI agent, a first plurality of workflows for responding to a query;
executing one or more workflows, from the plurality of workflows, by the AI agent to obtain a response to the query;
evaluating, by a separate LLM and a human agent, the AI agent's performance relating to obtaining the response to the query;
using the AI agent's performance and the evaluation of the AI agent's performance by the separate LLM and a human agent to generate a rubric; and
determining whether the evaluation by the separate LLM of the AI agent's performance exceeds a confidence threshold of the evaluation by the human agent of the AI agent's performance.

9. The method of claim 8, further comprising:
in response to determining that the evaluation by the separate LLM of the AI agent's performance does not exceeds the confidence threshold of the evaluation by the human agent of the AI agent's performance:
calibrating the separate LLM's evaluation to the human agent's evaluation of the AI agent's performance.

10. The method of claim 9, wherein the calibration relates to calibrating an evaluation score generated by the separate LLM for the AI agent's performance to the evaluation score generated by the human agent for the AI agent's performance.

11. The method of claim 8, wherein the confidence threshold relates to a level of similarity between evaluation of the AI agent by the separate LLM and the human agent.

12. The method of claim 8, further comprising, in response to determining that the evaluation by the separate LLM of the AI agent's performance exceeds the confidence threshold of the evaluation by the human agent of the AI agent's performance, determining the rubric to be ready to be used by the AI agent for the AI agent's self-evaluation.

13. The method of claim 8, wherein the self-evaluation by the AI agent of its performance relates to:
the AI agent iteratively processing the one or more workflows;
determining a performance score from each iteration of the iterative processing; and
determining, without human intervention, that the performance score for one of the iterations has exceeded the confidence level.

14. The method of claim 13, wherein determining the performance score from each iteration of the iterative processing is performed by:
the AI agent comparing its adherence to the rubric; and
generating the performance score based on the comparison.

15. A self-learning system for an artificial intelligence (AI) agent comprising:
communications circuitry for an AI agent to communicate with a first LLM; and
control circuitry configured to:
generate a workflow for responding to a query, wherein the workflow is generated leveraging a first LLM;
execute the generated workflow using the first LLM to obtain a response to the query;
calibrate the workflow based on an evaluation of the execution of the generated workflow from a human agent;
generate a rubric that includes data from the execution of the workflow and the calibration; and
determine adherence to the generated rubric for a subsequent workflow executed by the control circuitry.

16. The system of claim 15, further comprising, the control circuitry configured to:
determine that the subsequent workflow executed by the AI agent does not adhere to the generated rubric; and
in response to the determining that the subsequent workflow executed by the AI agent does not adhere to the generated rubric, use parameters from the rubric to execute a self-correction process, wherein the self-correction process includes re-executing the workflow by modifying parameters used in the workflow to the parameters from the rubric.

17. The system of claim 15, wherein calibrating the workflow includes the control circuitry configured to add a workflow step, remove a workflow step, modify a workflow step, or use a different tool to perform the workflow step.

18. The system of claim 15, further comprising, the control circuitry configured to calibrate the workflow based on an evaluation from a second LLM, wherein the second LLM being a separate LLM than the first LLM.

19. The system of claim 15, wherein determining adherence to the generated rubric for the subsequent workflow to be executed is performed by the control circuitry configured to independently reference its performance to the generated rubric.

20. The system of claim 19, further comprising, the control circuitry configured to determine the adherence to the generated rubric after the generated rubric is ready to be used for self-evaluation by the control circuitry, wherein the rubric is determined to be ready for self-evaluation when the response to the query exceeds an associated confidence threshold.
